(19) United States
(12) Patent Application Publication
(10) Pub. No.: US 2010/0019463 A1
(43) Pub. Date: Jan. 28, 2010

(54) GLIDING OR ROLLING BOARD

(75) Inventor: Henri RANCON, Annecy (FR)

Correspondence Address: GREENBLUM & BERNSTEIN, P.L.C., 1950 ROLAND CLARKE PLACE, RESTON, VA, 20191, US

(73) Assignee: SALOMON S.A.S., Metz-Tessy (FR)

(21) Appl. No.: 12/485,535

(22) Filed: Jun. 16, 2009

(30) Foreign Application Priority Data
Jul. 23, 2008 (FR) 08.04190

(51) Int. Cl. B62B 17/00

(52) U.S. Cl. 280/14.21

(57) ABSTRACT

A gliding or rolling board having a length extending longitudinally between a first end and a second end, a width extending transversely between a first edge and a second edge, as well as a height extending between a bottom surface and a top surface. The board includes a core extending along a substantial surface, the core housing at least one sliding rail, which extends transversely between a first side edge and a second side edge, and heightwise from a base to a top. The board includes an intermediate reinforcement that at least partially covers the top of the sliding rail, runs along at least one side edge from the top toward the base, and then extends away from the sliding rail.

### CROSS-REFERENCE TO RELATED APPLICATION

The instant application is based upon the French Patent Application No. 08.04190, filed Jul. 23, 2008, the disclosure of which is hereby incorporated by reference thereto, and the priority of which is hereby claimed under 35 U.S.C. §119.

### BACKGROUND OF THE INVENTION

1. Field of the Invention

The invention relates to gliding or rolling boards intended for the practice of a sport, such as snowboarding, water surfing, snow skiing, water skiing, skateboarding, and the like.

2. Background Information

A sports board, such as the aforementioned types, conventionally has a length measured along a longitudinal direction, between a first end and a second end, a width measured along a transverse direction, between a first edge and a second edge, as well as a height measured between a bottom surface and a top surface.

Heightwise, the board conventionally includes a lower reinforcement, an upper reinforcement, and a core therebetween. The term “lower” designates the reinforcement that is the closest to the ground when the board glides or rolls under normal conditions of use. By analogy, the term “upper” designates the reinforcement that is the farthest away from the ground. The core serves to separate the reinforcements. Thus, the board has a sandwich structure, which is both lightweight and mechanically strong. This is particularly the case for snowboards.

In the discipline of snowboarding, the rider has both feet retained on the board by means of bindings in first and second receiving zones, respectively. Each of the feet extends across the longitudinal direction of the board transversely, substantially perpendicular to the longitudinal direction. This makes it easier for the rider to apply lateral support forces with the heels or the toes, such as for steering or maintaining balance on the board.

The position of the feet is generally adjustable longitudinally. For example, the board can be provided to include sliding rails, which receive connecting elements to affix the bindings, i.e., the devices for retaining the feet. These elements can be bolts or nuts. Each sliding rail is housed in the core, which makes it possible to tighten the retaining devices on the top of the board. As a result, the rider can operate the board.

When being operated, the board is mechanically stressed. In particular, it receives impulse forces for making turns, performing acrobatic figures or jumps. In other words, the rider exerts forces on the board in order to manage the trajectory of the board, or gliding path, and to change direction.

The structure of the board is provided to withstand the impulse forces and stresses related to such steering of the board. Thus, the board maintains its cohesiveness, in the sense that its constituent elements remain assembled to one another according to the initial structure.

However, the board can become damaged. For example, the sliding rail can become deformed or it can be partially or completely detached from the remainder of the board. In other words, the sliding rail can tear apart or tend to tear apart.

Also, the board sometimes has a more or less extensive delamination in the area of a sliding rail. For example, a reinforcement becomes separated from the core.

Generally, this damage is caused by an intensive use of the board or an exceptional force, such as during an impact, for example.

A tearing apart, a delamination, or any other mechanical damage in the area of a sliding rail, makes it difficult or even impossible to use the board.

### SUMMARY OF THE INVENTION

The invention improves upon the mechanical strength of a board in the area of a sliding rail. More particularly, the invention increases the resistance of the board to tearing and/or delamination.

To this end, the invention proposes a gliding or rolling board having a length measured along a longitudinal direction, between a first end and a second end, a width measured along a direction perpendicular to the longitudinal, between a first edge and a second edge, as well as a height measured between a bottom portion and a top portion, the board including a core that extends along a substantial surface, the core housing at least one sliding rail, which extends transversely between a first edge and a second edge, and heightwise from a base up to a top.

The board according to the invention includes an intermediate reinforcement which at least partially covers the top of the sliding rail, runs along at least one edge, from the top down to the base, and then moves away from the sliding rail.

The intermediate reinforcement withstands part of the forces that stress the sliding rail in a direction spacing it in relation to the remainder of the board. In other words, the sliding rail is not the only element of the board that opposes forces, such as those exerted in tension by the screws holding a retaining device, or binding.

In fact, the intermediate reinforcement at least partially offsets the location in which the forces are applied. This enables a lower reinforcement, and/or the core, to contribute to the tear resistance. This reduces the mechanical stresses, in particular the forces per area unit.

Among the resulting advantages is an increased strength of the board, in particular in terms of a greater tear resistance of the sliding rail and a reduced risk of delamination. Incipient ruptures occur rarely, or are delayed. The fatigue strength of the board is improved. The board has a longer useful life.

### BRIEF DESCRIPTION OF DRAWINGS

Other characteristics and advantages of the invention will be better understood from the description that follows, with reference to the annexed drawings illustrating, by way of non-limiting embodiments, how the invention can be made and used, and in which:

FIG. 1 is a perspective view of a board according to a first embodiment of the invention;

FIG. 2 is a transverse cross-sectional view taken along the line II-II of FIG. 1;

FIG. 3 is a cross-sectional view similar to that of FIG. 2, of an alternative construction which is part of the first embodiment;

FIG. 4 is a transverse cross-sectional view taken along the line IV-IV of FIG. 1;

FIG. 5 is a perspective view of a sliding rail for the board of FIG. 1;

FIG. 6 is a cross-sectional view similar to that of FIG. 4, of a second embodiment of the invention;

FIG. 7 is a perspective view of a board according to a third embodiment of the invention;

FIG. 8 is a transverse cross-sectional view taken along the line VIII-VIII of FIG. 7;

FIG. 9 is a schematic, transverse cross-sectional view of a sliding rail preform, which is provided for a board according to any embodiment;

FIG. 10 is a transverse cross-sectional view of the sliding rail made with the preform according to FIG. 9;

FIG. 11 is a view similar to that of FIG. 9, of a first alternative construction;

FIG. 12 is a view similar to that of FIG. 10, of the first alternative construction;

FIG. 13 is a view similar to that of FIG. 9, of a second alternative construction;

FIG. 14 is a view similar to that FIG. 9, of a third alternative construction,

FIG. 15 is a transverse cross-sectional view of a board before completion, of a fourth embodiment of the invention;

FIG. 16 is a view similar to that of FIG. 15, of a completed board;

FIG. 17 is a view similar to that of FIG. 16, of a fifth embodiment of the invention.

### DETAILED DESCRIPTION OF THE INVENTION

Although the embodiments disclosed herein and those described below in connection with the drawings relate to a snowboard, it is to be understood that the invention encompasses the structure of other boards adapted to the practice of various sports, as mentioned above.

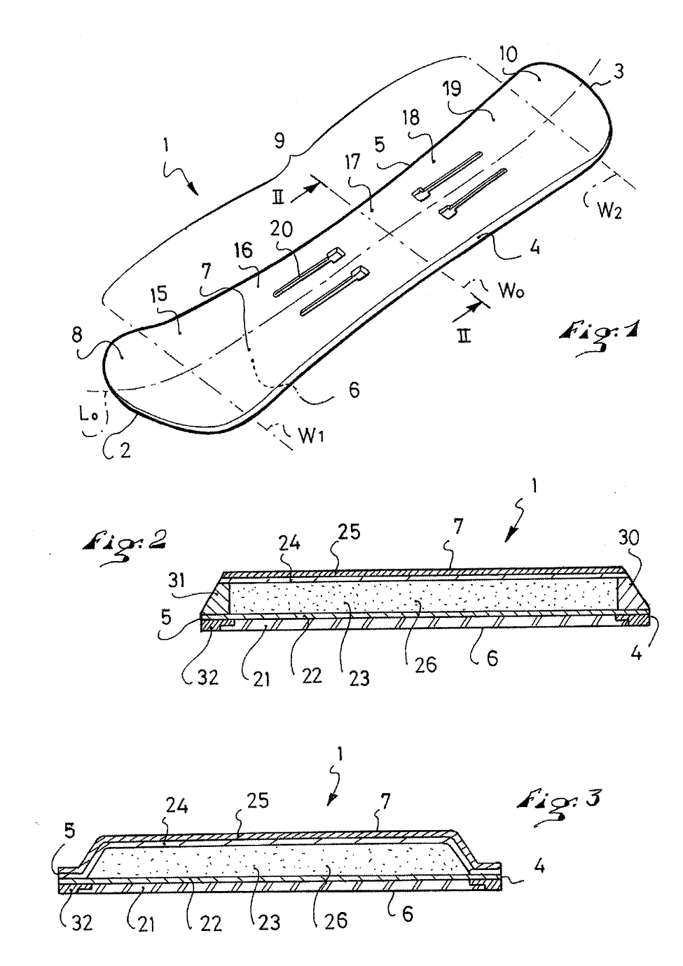

The first embodiment is illustrated with reference to FIGS. 1 to 5.

In a known manner, as shown in particular in FIG. 1, a snowboard 1 has a length measured along a longitudinal direction, between a first end 2 and a second end 3. The longitudinal direction is referenced by means of the central longitudinal axis Lo. The first 2 and second 3 ends are each rounded, but could alternatively have a different shape, such as that of a pointed tip, or that of a fin. The board 1 also has a width measured along a transverse direction and perpendicular to the longitudinal, between a first side edge 4 and a second side edge 5, as well as a height measured between a bottom portion, or gliding surface 6, and a top portion, or receiving surface 7. The transverse direction is referenced by means of the median transverse axis Wo. The circumference, or periphery, of the board includes the ends and the side edges. For each side edge, the dimension line, according to the embodiment shown, is outwardly concave in relation to the central longitudinal axis Lo.

The transverse direction, such as along axis Wo, is perpendicular to the longitudinal direction Lo, and parallel to the gliding surface 6 or generally parallel thereto.

The board 1 also has, from the first end 2 to the second end 3, a first end zone 8, a first contact line W1, a central zone 9, a second contact line W2, and a second end zone 10. The central zone 9 itself successively includes, between the contact lines W1, W2, a first intermediate zone 15, a first retaining zone 16, a second intermediate zone 17 arranged in the area of the median axis Wo, a second retaining zone 18, and a third intermediate zone 19. The end 8, intermediate 15, retaining 16, intermediate 17, retaining 18, intermediate 19, and end 10 zones follow one another longitudinally.

Each retaining zone 16, 18 is provided to receive a device for retaining a user's foot. The devices, not shown, can be affixed to the board 1 in the area of the sliding rails 20, as explained in detail below.

Each of the contact lines W1, W2 is a substantially transverse line of the board 1, in the area of which the gliding surface 6 contacts a planar surface, when the board 1 rests on such surface without any external influence.

The general appearance of the board 1 is that of an elongated plate. According to the embodiment shown, the bottom portion 6 is slightly concave between the contact lines W1, W2. The bottom portion 6 has an inner hollow or rounded portion that extends along the central zone 9, substantially from the first 15 to the third 19 intermediate zone. In the embodiment shown, the rounded portion has a regular geometry. The top portion 7 has two slight projections formed by greater thickness in the retaining zones 16, 18. Also, the board is slightly reduced widthwise between the edges 4, 5, in the area of the second intermediate zone 17.

The height of board 1 is shown in the cross-sectional view of FIG. 2.

From the gliding surface 6 to the receiving surface 7, the board 1 includes a sole 21, a lower reinforcement layer 22, a core 23, an upper reinforcement layer 24, and a protective layer 25. The lower reinforcement 22 is that which is the closest to the ground when the board glides under normal operating conditions. Similarly, the upper reinforcement 24 is the furthest away from the ground under the same conditions.

Depending upon the type of board, the number of reinforcements, or reinforcement layers, can be modified so as to be more than two.

Each reinforcement 22, 24 extends parallel to bottom portion 6 or to the top portion 7. The board may include no protective layer.

The sole 21 is made, for example, with a plastic material containing polyethylene. The protective layer 25 is made, for example, with a plastic material containing a mixture of polyamide and polyurethane, or acetyl-butadiene-styrene.

According to the first embodiment, the core 23 includes a main body 26, which provides it with its general appearance. For example, the main body 26 includes wood, a foam of synthetic material, or any other material. The core 23 extends along a substantial surface of the board 1, i.e., as near as makes no difference, lengthwise from the first end 2 to the second end 3, and widthwise from the first edge 4 to the second edge 5. However, the core 23 could extend along a substantial surface while alternatively remaining set back in relation to an end or an edge.

The reinforcements 22, 24 and the core 23 form a sandwich panel that extends along at least 50% of the board surface, and, in a particular embodiment, substantially along the entire surface.

The board 1 further includes a first sidewall 30 located in the area of the first side edge 4, as well as a second sidewall 31 located in the area of the second side edge 5. This provides the board with a box-type structure. A sidewall 30, 31 includes a synthetic material, such as acetyl-butadiene-styrene, for example.

Alternatively, FIG. 3 illustrates an alternative embodiment, whose construction includes part of the first embodiment of the invention. This alternative excludes the sidewalls. The first 22 and second 24 reinforcements join one another directly. This provides the board with a shell-type structure, or a cap structure.

Any other structure can be provided in additional alternative embodiments. For example, one portion of the board can have a box-type structure, whereas another has a shell-type/cap structure.

A peripheral running edge 32 that includes a flange in cooperation with the sole 21 is also provided in the illustrated embodiment. The running edge 32 is continuous but could also be sectioned, or may not extend along the entire periphery. For example, it could include a portion located along the first edge 4 and a portion located along the second edge 5. The running edge 32 can include, or be made of, a metal or a metal alloy, such as steel, or the like.

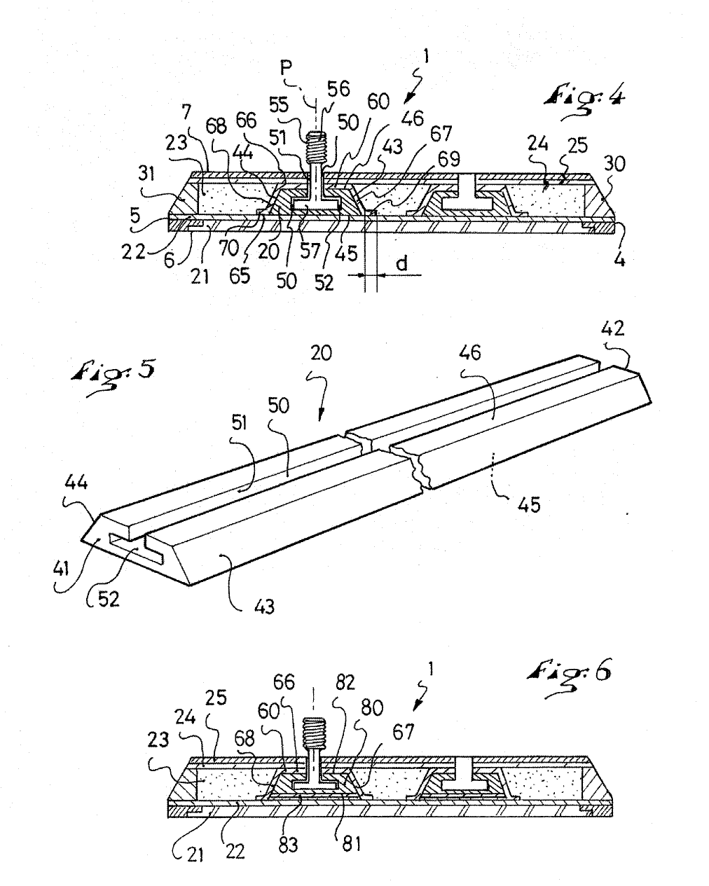

In any case, the board I includes one or more sliding rails 20, as shown in FIGS. 1, 4, and 5. A sliding rail 20 is an elongated element that extends longitudinally from a first end 41 to a second end 42, transversely between a first edge 43 and a second edge 44, and heightwise between a lower portion, or base 45, and a top portion, or top 46. The sliding rail 20 has a longitudinal opening 50, which is oriented to extend from the first end 41 to the second end 42. The longitudinal opening 50 has a narrow portion 51, which opens out in the area of the top 46. A broader portion 52 extends the narrow portion 51 of the opening 50 along a direction spaced from the top 46. According to the first embodiment of the invention, the opening 50 of the sliding rail 20 has a T-shaped transverse cross section. This shape is not limiting, as the invention encompasses other shapes. In FIG. 4 a sliding rail 20 receives a connecting element 55, provided to retain a retaining device, or binding (not shown). The connecting element 55 is a screw or screw-threaded connector, for example, which includes a threaded portion 56 projecting upward above the sliding rail 20 and above the board 1. The screw 55 also includes a head 57 wider than the narrow portion 51 of the opening 50. The head 57 is housed in the wide portion 52 of the opening. Thus, the screw 55 retains a retaining device/binding.

According to the invention, the board 1 includes at least one intermediate reinforcement 60 that at least partially covers the top 46 of the sliding rail 20, runs along at least one edge 43, 44 from the top 46 toward the base 45, and then moves away from the sliding rail. The intermediate reinforcement is provided to oppose a force tending to tear apart the sliding rail 20, which force is exerted by the screws 55 in a direction spaced from the lower reinforcement 22. Thus, the intermediate reinforcement 60 withstands at least a portion of the tearing forces. These forces are therefore distributed over a larger surface than the base 45 of the sliding rail 20. As a corollary, the mechanical stresses in the area of the sliding rail decrease. It advantageously follows that the tear resistance of the sliding rail 20 is increased, and that the delamination resistance of the board 1 is increased.

According to the first embodiment of the invention, in a non-limiting manner, the base 45 of the sliding rail 20 is broader than the top 46. Consequently, the sliding rail 20 has a trapezoidal transverse cross section. This widens the contact surface between the sliding rail 20 and the lower reinforcement 22. Because the sliding rail 20 is adhered to the lower reinforcement 22, a widened surface already improves the tear resistance.

The intermediate reinforcement 60 is configured to cover the sliding rail 20, and to extend transversely on both sides of the base 45 of the sliding rail. The intermediate reinforcement 60 includes a base 65, a top 66, as well as a first wall 67 and a second wall 68. The walls 67, 68 connect the base 65 to the top 66, by covering the first edge 43 and the second edge 44, respectively, of the sliding rail. As a corollary, the base 65 of the intermediate reinforcement 60 includes a first subdivision 69 and a second subdivision 70. It follows that, along the transverse direction, the intermediate reinforcement 60 includes the first subdivision 69, the first wall 67, the top 66, the second wall 68, and the second subdivision 70. These various portions 69, 67, 66, 68, 70 of the reinforcement 60 extend one another to form a unitary element, i.e., a one-piece element.

The reinforcement 60 is made of any known material. For example, the reinforcement 60 includes resin-impregnated fibers, metal, or any equivalent. According to the first embodiment, the intermediate reinforcement 60 is of the same type as the lower 22 and upper 24 reinforcements. This means that the reinforcements 60, 22 and 24 include the same materials.

The base 65 of the intermediate reinforcement 60 extends transversely in the area of the base 45 of the sliding rail. The base 65 is affixed directly to the lower reinforcement 22. In other words, each subdivision 69, 70 is affixed directly to the lower reinforcement 22, or the intermediate reinforcement 60 is affixed directly to the lower reinforcement 22. This enables a transmission of the tearing forces to the lower reinforcement 22. Because the subdivisions 69, 70 each extend away from the sliding rail 20, the tear resistance active surface is widened. Thus, the stresses exerted are reduced.

According to the first embodiment, the subdivisions 69, 70 extend over a short distance, between 5 mm and 5 cm. In fact, the intermediate reinforcement 60 remains set back, at least transversely, in relation to the edges 4, 5 of the board. This limits the weight of the intermediate reinforcement 60. Consequently, the board 1 remains lightweight.

Still in the context of a better mechanical strength of the board, the top 66 of the intermediate reinforcement 60 is affixed directly to the upper reinforcement 24. In other words, the intermediate reinforcement 60 is affixed directly to the upper reinforcement 24. It follows that, in addition to covering the sliding rail 20, the intermediate reinforcement 60 connects the lower 22 and upper 24 reinforcements to one another directly. This direct connection reinforces the structure of the board and facilitates a more direct transmission of sensory information.

Also, the intermediate reinforcement 60 is in direct contact with the sliding rail 20, and the intermediate reinforcement 60 is also in direct contact with the core 23. In fact, the intermediate reinforcement 60 is sandwiched between the sliding rail 20 and the core 23 in the area of the walls 67, 68, i.e., along the walls 67, 68. A greater cohesiveness in the structure of the board is thereby achieved.

Because it covers the sliding rail 20, the intermediate reinforcement 60 has an inner envelope with a trapezoidal cross section. This cross section is demarcated by the top 66, the walls 67, 68, as well as an imaginary line that joins the walls in the area of the base 65. Due to this trapezoidal shape, the core 23 contributes to the resistance of the board 1 against the tearing apart of the sliding rail.

The sliding rail 20 and the intermediate reinforcement 60 are transversely symmetrical, in relation to a longitudinal central and vertical plane P. This plane P passes in the center of the opening 50, the bases 45, 65 and the tops 46, 66 of the sliding rail 20 and of the intermediate reinforcement 60.

The plane P is perpendicular to the bases 45, 65 and the tops 46, 66. This symmetry allows for a uniform distribution of the forces, in particular the tearing forces. The symmetry also facilitates the manufacture of the board. Indeed, it is not necessary to reference a direction for the assembly of the sliding rail.

The manufacture of the board is conventional, in the sense that its constituent elements are arranged in a mold. Then, a rise in temperature and pressure provides cohesiveness to the board. The sliding rail 20 does not have its final form in the mold, as is described in greater detail below. In fact, it is a preform of the sliding rail 20 that is positioned in the mold, prior to the narrow portion of the opening 50 being made. Upon removal of the sliding rail from the mold, the portion 51 is made by removal of material.

In a non-limiting manner, the board 1 according to the first embodiment has four sliding rails 20, two of which are located in the first retaining zone 16, and the other two in the second retaining zone 18. There are two sliding rails 20 per retaining device. The four sliding rails 20 are oriented along the longitudinal direction Lo of the board 1. Two sliding rails of the same zone 16, 18 are opposite one another transversely. Two sliding rails 20 of two different zones 16, 18 are aligned with one with another. The sliding rails are symmetrically arranged transversely along the central longitudinal axis Lo. This arrangement makes it easier to find an optimal steering position.

The other embodiments of the invention, as well as embodiments of the elements, are described hereinafter with reference to FIGS. 6 to 17. For reasons of convenience and to facilitate understanding, the elements that are common with the first embodiment are designated by the same reference numerals. The new elements are designated by new reference numerals.

In the second embodiment according to FIG. 6, the board 1 has a sole 21, a lower reinforcement 22, a core 23, an upper reinforcement 24, and a protective layer 25. This embodiment also includes at least one sliding rail 80 and one intermediate reinforcement 60 similar to that according to the first embodiment.

The structure of the sliding rail 80 is what differentiates the second embodiment from the first. The sliding rail has a reduced thickness between its base 81 and its top 82. A cap 83 extends between the walls 67, 68 of the intermediate reinforcement 60, away from the lower reinforcement 22. The top 66 and walls 67, 68 of the intermediate reinforcement 60 form a cavity which is closed by means of the cap 83. The sliding rail 80 is housed within the closed cavity defined by the cap 83, the walls 67, 68, and the top 66 of the reinforcement 60. The core 23 extends partially between the lower reinforcement 22 and the cap 83, in the intermediate reinforcement 60. This structure is provided to lighten the board 1.

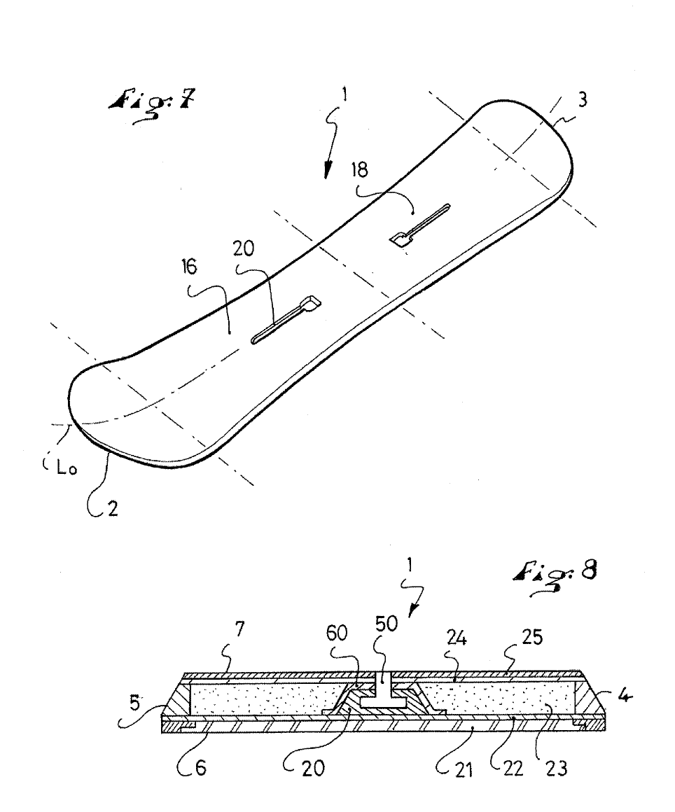

The third embodiment is shown in FIGS. 7 and 8. In this embodiment, the board 1 has only two sliding rails 20, one being located in the first retaining zone 16 and the other in the second retaining zone 18. Each sliding rail 20 is oriented along the central longitudinal direction Lo. In a non-limiting manner, the structure of the sliding rail 20 is that according to FIG. 1.

FIGS. 9 and 10 explain the making of a sliding rail 20. In FIG. 9, a preform 100 of the sliding rail 20 has a base 45, a top 46, a first edge 43, and a second edge 44. Only the wide portion 52 of the opening 50 is demarcated. The preform 100 is a shaped element manufactured using any technique, such as extrusion, injection molding, or the like. The preform includes a plastic material such as, for example, polyurethane, polyamide, or any equivalent. During the manufacture of the board 1, the preform 100 is positioned in the mold, as mentioned previously. At the end of the manufacture, the narrow portion 51 of the opening 50 is made, for example by machining. Thus, the sliding rail 20 has the appearance shown in FIG. 10. The sliding rail 20 is a unitary element, which includes only one material. This representation must be considered in correlation, for example, with FIG. 4. An advantage of this technique, which involves completing the opening 50 after the molding process, is avoiding the intrusion of adhesive or resin inside the sliding rail 20. Thus, the ability to guide the screws 55 properly is preserved.

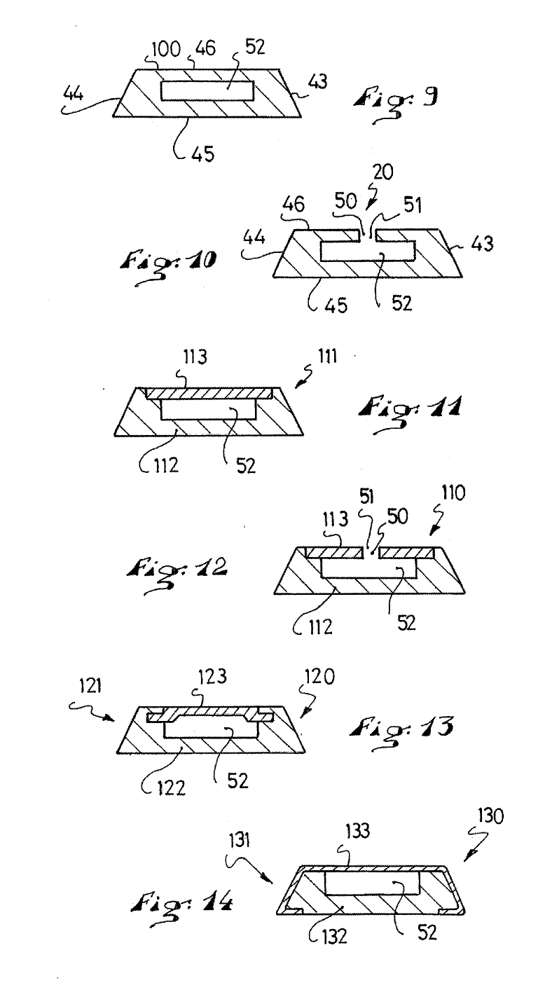

FIGS. 11 and 12 depict the manufacture of a sliding rail 110 for a first alternative construction. The sliding rail 110 includes a plurality of pieces, for example two, and is made from a preform 111, which includes a main body 112 and a cover 113. The implementation for the manufacture of the board is similar to that according to FIGS. 9 and 10. However, with the sliding rail 110 according to the first alternative construction, it is possible to use a manufacturing technique other than extrusion or injection. For example, machining is appropriate. It is also possible to provide different materials for the body 112 and the cover 113. Thus, the sliding rail includes a plurality of materials, for example, a body 112 made of plastic and a cover 113 made of metal. This provides a more rigid base for the screw 55. However, the cover can include resin-impregnated fibers, or a plastic material.

FIG. 13 shows a second alternative construction of a sliding rail 120, which includes a preform 121, a main body 122, and a cover 123. The main body 122 is partially overmolded here on the cover 123.

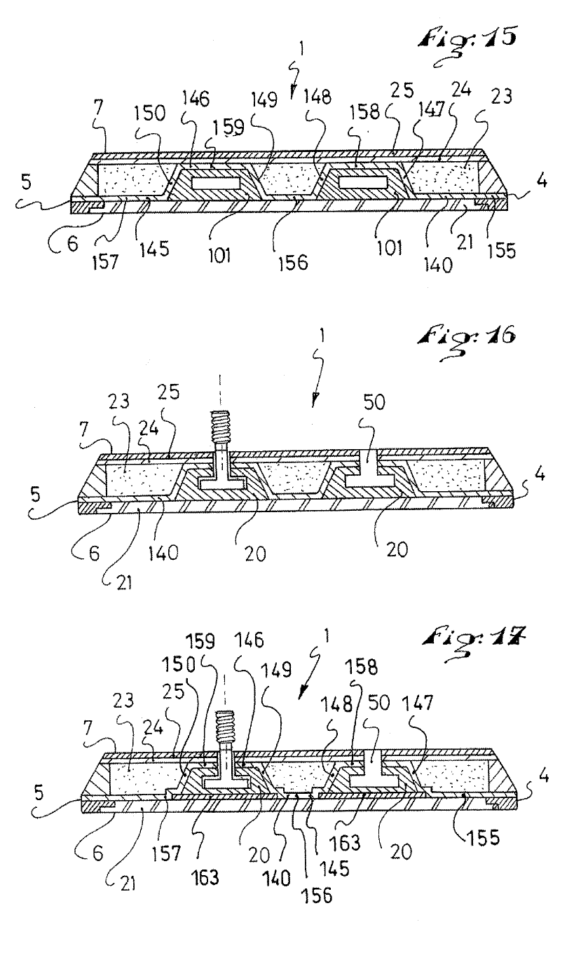

FIG. 14 shows a third alternative construction of a sliding rail 130, which includes a preform 131, a main body 132, and a cover 133. The latter extends above, on the sides of, and beneath the main body 132 to form the preform 131.

The fourth embodiment is described hereinafter with reference to FIGS. 15 and 16. A board 1 is shown according to the same transverse cross section in two different states: in FIG. 15, the manufacture of the board is not completed, whereas it is completed in FIG. 16.

This embodiment includes a sole 21, a core 23, an upper reinforcement 24, and a protective layer 25. There is also at least one sliding rail 20, two, e.g., which are opposite one another transversely.

According to the fourth embodiment, an intermediate reinforcement 140 extends transversely from the first lateral edge 4 to the second lateral edge 5 of the board 1. The intermediate reinforcement 140 also extends longitudinally from the first end 2 to the second end 3. This avoids the use of a lower reinforcement, as is the case in the preceding embodiments. Thus, the board 1 is lighter and, as a result, it is easier for the rider to perform acrobatic figures.

The intermediate reinforcement 140 covers each sliding rail 20. Here, in a non-limiting manner, the intermediate reinforcement 140 includes a base 145, a top 146, and first 147, second 148, third 149, and fourth 150 walls. The base 145 has three subdivisions 155, 156, 157 and the top 146 has two subdivisions 158, 159. The base 145 is connected to the sole 21 and the top 146 is connected to the upper reinforcement 24.

The board according to the fourth embodiment includes four sliding rails, as in the first embodiment, but it could alternatively include a different number of sliding rails. For example, one can provide two sliding rails as in the third embodiment.

The fifth embodiment is described hereinafter with reference to FIG. 17. A board 1 is shown in transverse cross section. This embodiment includes a sole 21, a core 23, an upper reinforcement 24, and a protective layer 25. Also included is at least one sliding rail 20, or, e.g., two that are opposite one another transversely.

As is the case the fourth embodiment, the fifth embodiment calls for an intermediate reinforcement 140. The latter extends in the same manner and includes the same elements 145 to 150 and 155 to 159.

Here again, the board includes four sliding rails, but could have a different number thereof.

A specific characteristic of the fifth embodiment is that a cap 163 extends between the sliding rail 20 and the sole 21. For example, one cap 163 is provided per sliding rail. However, one could alternatively provide a cap 163 for a reduced number of sliding rails.

Each cap 163 connects two walls 147, 148, 149, 150 of the intermediate reinforcement 140 to one another. Two connected walls are each located on one side of the sliding rail 20.

Each cap 163 connects the sliding rail 20 to the sole 21. In fact, a cap 163 extends parallel to the sole 21, in the extension of the base 145 of the intermediate reinforcement.

A cap 163 includes any appropriate material, such as, for example, resin-impregnated fibers or any equivalent. According to the fifth embodiment of the invention, a cap 163 and the intermediate reinforcement 140 include the same materials. This provides the board structure with greater homogeneity.

The invention is made from materials and according to techniques of implementation known to the one with ordinary skill in the art.

The invention is not limited to the particular illustrated embodiments described hereinabove, and includes all of the technical equivalents that fall within the scope of the claims which follow.

For example, the subdivisions of a base of an intermediate reinforcement can extend transversely away from the lower reinforcement. In this case, the subdivisions become incrusted in the core; the intermediate reinforcement does not connect the lower and upper reinforcements directly.

Also, the invention, illustratively disclosed herein, suitably may be practiced in the absence of any element which is not specifically disclosed herein.

1. A gliding or rolling board comprising:
a length measured along a longitudinal direction, between a first end and a second end;
a width measured along a transverse direction, between a first side edge and a second side edge;
a height measured between a bottom portion and a top portion;
a core extending longitudinally along a substantial extent of said length;
at least one sliding rail substantially housed within the core, said sliding rail extending transversely between a first edge and a second edge of the sliding rail, and heightwise from a base of the sliding rail to a top of the sliding rail;
an intermediate reinforcement at least partially covering the top of the sliding rail, said intermediate reinforcement extending along at least one edge of the sliding rail from the top toward the base of the sliding rail, and extending from the base away from the sliding rail.

2. A board according to claim 1, wherein:
the intermediate reinforcement comprises:
a base and a top;
a first wall connecting the base to the top;
a second wall connecting the base to the top;
the base including a first subdivision extending away from the first wall and a second subdivision extending away from the second wall.

3. A board according to claim 1, wherein:
the intermediate reinforcement comprises:
a base and a top;
a first wall, a second wall, a third wall, and a fourth wall, said first, second, third, and fourth walls extending between the base and the top;
the base having three subdivisions;
the top having two subdivisions.

4. A board according to claim 1, further comprising:
a sole;
a cap connecting the sliding rail to the sole.

5. A board according to claim 1, further comprising:
the intermediate reinforcement comprises:
a top;
a first wall extending downwardly from the top;
a second wall extending downwardly from the top;
the top and the first and second walls of the intermediate reinforcement form a cavity open downwardly; and
a cap closing said downwardly open cavity, the sliding rail being housed within said closed cavity.

6. A board according to claim 1, further comprising:
a lower reinforcement and an upper reinforcement;
the intermediate reinforcement directly connecting together the lower reinforcement and the upper reinforcement.

7. A board according to claim 1, wherein:
the intermediate reinforcement is sandwiched between the sliding rail and the core along the walls of the intermediate reinforcement.

8. A board according to claim 1, wherein:
the intermediate reinforcement includes resin-impregnated fibers.

9. A board according to claim 1, wherein:
the sliding rail has a trapezoidal transverse cross section.

10. A board according to claim 1, wherein:
the sliding rail is a one-piece element and consists of one material.

11. A board according to claim 1, wherein:
the sliding rail comprises a plurality of materials and/or a plurality of parts assembled together.

12. A board according to claim 1, wherein:
the intermediate reinforcement extends transversely from the first side edge to the second side edge of the board.

13. A board according to claim 1, wherein:
the intermediate reinforcement remains set back, at least transversely, in relation to the side edges of the board.

14. A board according to claim 1, wherein:
said at least one sliding rail comprises four sliding rails.

15. A board according to claim 1, wherein:
said at least one sliding rail comprises two sliding rails.
